(19) United States
(12) Patent Application Publication
(10) Pub. No.: US 2024/0157577 A1
(43) Pub. Date: May 16, 2024

(54) TRANSPORT APPARATUS

(71) Applicant: DAIHEN Corporation, Osaka (JP)

(72) Inventors: Hiroto SAKAHARA, Osaka (JP); Yoshiyuki MATSUZAKI, Osaka (JP)

(73) Assignee: DAIHEN Corporation, Osaka (JP)

(21) Appl. No.: 18/491,769

(22) Filed: Oct. 21, 2023

(30) Foreign Application Priority Data
Nov. 11, 2022 (JP) 2022-180725

(51) Int. Cl. B25J 15/00; B25J 15/06

(52) U.S. Cl. CPC B25J 15/0028; B25J 15/0033; B25J 15/0608; B25J 13/085

(57) ABSTRACT

A transport apparatus that can transport heavy transport target objects that are difficult for humans to transport. A transport apparatus includes first and second hand portions that are arranged at a distance from each other in a first direction in a horizontal plane and configured to simultaneously hold a transport target object; a first moving portion that moves each of the first and second hand portions in the first direction; a second moving portion that moves the first moving portion in a second direction that is perpendicular to the first direction in the horizontal plane; a third moving portion that moves the second moving portion in a vertical direction; and a wheeled platform to which the third moving portion is fixed. By utilizing this configuration, it is possible to move the first and second hand portions holding the transport target object, with a simple configuration, and increase the weight capacity.

### CROSS REFERENCE TO RELATED APPLICATION

This application claims priority of Japanese Patent Application No. 2022-180725 filed Nov. 11, 2022. The entire contents of which are hereby incorporated by reference.

### FIELD OF THE INVENTION

This invention relates to a transport apparatus that can move a pair of hand portions that simultaneously hold a transport target object, in three axial directions.

### BACKGROUND

Conventionally, there is a need to transport heavy transport target objects that are difficult for humans to transport, such as welding jigs and plasma power supplies, at manufacturing sites. It is conceivable to use a forklift in order to transport such a transport target object, but the weight of the transport target object may not be so large that the object has to be transported using a forklift. Also, if a transport target object is not placed on a pallet, it is difficult to transport the object using a forklift.

It is also conceivable to transport such a transport target object using a manipulator, but, if the hand portion of the manipulator cannot hold the transport target object near its center of gravity, a moment will be applied to the hand portion when the transport target object is transported. In order to cope with this moment, the strength of the manipulator has to be increased, resulting in a larger manipulator.

This moment issue can be solved by causing a dual-armed manipulator to simultaneously hold a transport target object at two points. For such dual-arm robots, innovations have been made to improve the operating range and workability (see JP 2020-189364A and JP 2022-108837A, for example).

However, a versatile dual-arm robot has a large number of axes, and thus the manipulator itself becomes heavy. Therefore, in order to increase the weight capacity, it is necessary to use a high-power motor for each axis, which leads to an issue that the size of the dual-arm robot becomes larger. On the other hand, if the size of the dual-arm robot is not increased, the weight capacity becomes smaller.

### SUMMARY

The present invention was made in order to solve the above-described issues, and it is an object thereof to provide a transport apparatus that can transport heavy transport target objects that are difficult for humans to transport, with a simpler configuration.

In order to achieve the above-described object, an aspect of the present invention is directed to a transport apparatus including: first and second hand portions that are arranged at a distance from each other in a first direction in a horizontal plane and configured to simultaneously hold a transport target object; a first moving portion that moves each of the first and second hand portions in the first direction; a second moving portion that moves the first moving portion in a second direction that is perpendicular to the first direction in the horizontal plane; a third moving portion that moves the second moving portion in a vertical direction; and a wheeled platform to which the third moving portion is fixed.

With the transport apparatus according to an aspect of the present invention, the weight capacity can be increased by simplifying the configuration for moving a pair of hand portions that simultaneously hold a transport target object.

### BRIEF DESCRIPTION OF THE DRAWINGS

FIG. 1 is a perspective view showing the configuration of a transport apparatus according to an embodiment of the present invention.

FIG. 2A is a front view showing an example of hand portions and a transport target object in the embodiment.

FIG. 2B is a front view showing an example of the hand portions and the transport target object in the embodiment.

FIG. 2C is a front view showing an example of the hand portions and the transport target object in the embodiment.

FIG. 2D is a front view showing an example of the hand portions and the transport target object in the embodiment.

FIG. 3 is a functional block diagram showing the function of the transport apparatus in the embodiment.

FIG. 4 is a flowchart showing an operation of the transport apparatus in the embodiment.

FIG. 5A is a perspective view showing an example of the transport target object in the embodiment.

FIG. 5B is a plan view showing an example of the transport target object and the holding portions in the embodiment.

### DETAILED DESCRIPTION

Below, a transport apparatus according to the present invention will be described by way of the embodiment. The constituent elements and steps denoted by the same reference numerals in the following embodiment are similar or corresponding constituent elements and steps, and thus a description thereof may not be repeated. The transport apparatus according to this embodiment includes first to third moving portions that move two hand portions in three axial directions, wherein the third moving portion on the base end side is fixed to a wheeled platform.

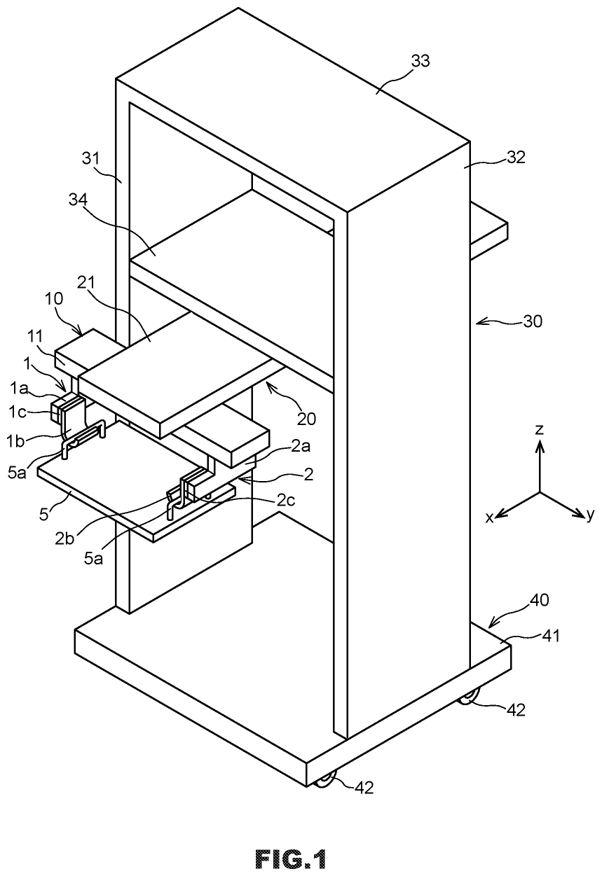

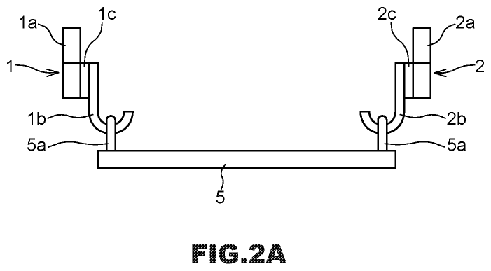

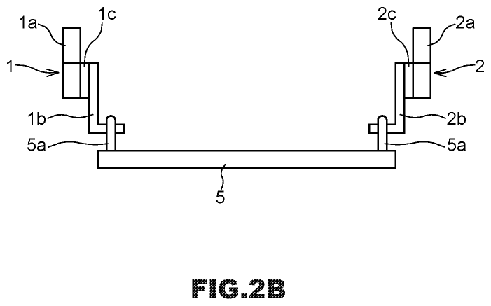

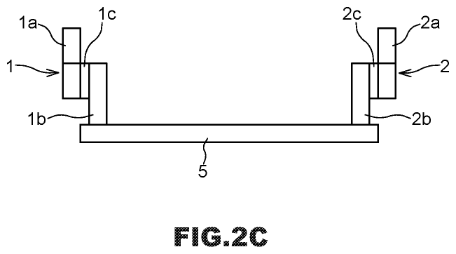

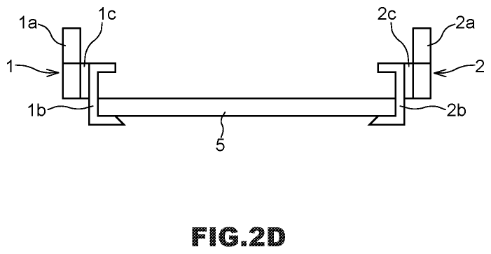

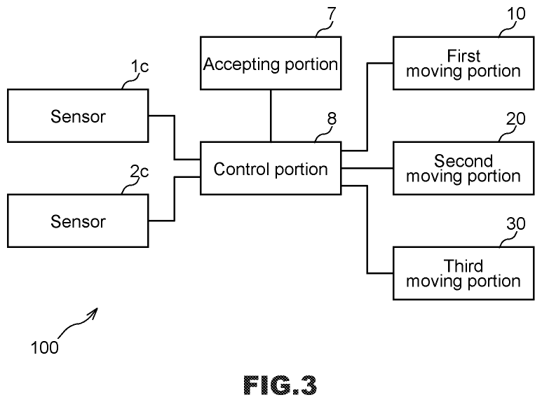

FIG. 1 is a perspective view showing a transport apparatus 100 according to this embodiment, FIG. 2A is a front view showing first and second hand portions 1 and 2 holding a transport target object 5, and FIG. 3 is a functional block diagram showing the function of the transport apparatus 100.

The transport apparatus 100 includes the first hand portion 1, the second hand portion 2, an accepting portion 7, a control portion 8, a first moving portion 10, a second moving portion 20, a third moving portion 30, and a wheeled platform 40.

The first hand portion 1 and the second hand portion 2 are arranged at a distance from each other in a first direction in a horizontal plane. The first hand portion 1 and the second hand portion 2 simultaneously hold the transport target object 5. The above-described moment issue can be solved by causing the first and second hand portions 1 and 2 to simultaneously hold the transport target object 5, and thus the first to third moving portions 10, 20, and 30 do not need to be enlarged. The first hand portion 1 may include a first base portion 1a, a first holding portion 1b that holds the transport target object 5, and a first sensor 1c for acquiring the weight of the transport target object 5 held by the first holding portion 1b, for example. The second hand portion 2 may include a second base portion 2a, a second holding portion 2b that holds the transport target object 5, and a second sensor 2c for acquiring the weight of the transport target object 5 held by the second holding portion 2b, for example. The first and second holding portions 1b and 2b may be connected directly or indirectly to the first and second base portions 1a and 2a, respectively.

The first sensor 1c acquires the weight applied to the first holding portion 1b, and the second sensor 2c acquires the weight applied to the second holding portion 2b. The sum of the weights acquired by the first and second sensors 1c and 2c may be the weight of the transport target object 5, or a value obtained by adding the weights of the first and second holding portions 1b and 2b to the weight of the transport target object 5, for example. The first and second sensors 1c and 2c may be sensors for detecting external forces, or weight sensors, for example. The sensors for detecting external forces may be 3-axis or 6-axis force sensors, for example. If the first and second sensors 1c and 2c are sensors for detecting external forces, the sensors are preferably arranged such that they can measure the weight of the transport target object 5 held by the first and second hand portions 1 and 2.

The first and second hand portions 1 and 2 are moved by the first to third moving portions 10, 20, and 30 in a first direction and a second direction that are in a horizontal plane and in a vertical direction. The second direction is a direction that is perpendicular to the first direction. That is to say, the first and second hand portions 1 and 2 are moved in each of the three axes in a cartesian coordinate system. In this embodiment, it is assumed that the first direction, the second direction, and the vertical direction are respectively the y-axis direction, the x-axis direction, and the z-axis direction shown in FIG. 1.

The method in which the first and second hand portions 1 and 2 hold the transport target object 5 is not limited. As shown in FIGS. 1 and 2A, the first and second hand portions 1 and 2 may hold the transport target object 5 in a suspending manner. In this embodiment, a case will be mainly described in which the first and second holding portions 1b and 2b that hold the transport target object 5 in a suspending manner each have a cross-section in the shape of the letter “J”, but the first and second holding portions 1b and 2b may have cross-sections in other shapes as will be described later. The first and second hand portions 1 and 2 may hold the transport target object 5 in a sandwiching manner from both sides, may hold the transport target object 5 by means of electromagnets, may hold the transport target object 5 by means of a vacuum adsorption mechanism, or may hold the transport target object 5 using other methods, as will be described later.

The transport target object 5 is not particularly limited, but may be an object used at manufacturing sites, such as a plasma power supply or a welding jig, for example. The weight of the transport target object 5 is not particularly limited, but may be a weight that makes it difficult for humans to transport the object, such as 30 kg or more or 50 kg or more, for example. The weight of the transport target object 5 may be a weight that does not require to use a large transport vehicle such as a forklift, such as 200 kg or less, 150 kg or less, or 100 kg or less, for example.

FIG. 1, etc. show a case in which the transport target object 5 is a plate-like member, for example, but the transport target object 5 may be a three-dimensional object or a plate-like member on which another device or the like is placed. In the latter case, for example, the plate-like member and the device or the like placed on the plate-like member may be the transport target object 5. When the transport target object 5 is suspended by the first and second hand portions 1 and 2, the transport target object 5 may be provided with two holdable portions 5a such as handles, as shown in FIG. 1, etc. The transport target object 5 may be held by the first and second hand portions 1 and 2 by causing the first and second holding portions 1b and 2b to suspend the object at the holdable portions 5a.

The accepting portion 7 may accept operations and instructions from the user. The accepting portion 7 may accept operations and instructions related to the first to third moving portions 10, 20, and 30, or may accept operations and instructions related to the wheeled platform 40, for example. The acceptance may be acceptance of information input from an input device (e.g., a keyboard, a mouse, a touch panel, etc.) or reception of information transmitted via a wired or wireless communication line, for example. The accepting portion 7 may or may not include an accepting device (e.g., an input device, a communication device, etc.). The accepting portion 7 may be realized by hardware, or software such as a driver that drives a given device.

The control portion 8 controls each of the first moving portion 10, the second moving portion 20, and the third moving portion 30. This control by the control portion 8 causes the transport target object 5 to be held or released by the first and second hand portions 1 and 2, for example. This control also causes the transport target object 5 to be locally transported (e.g., positioned). For example, if the wheeled platform 40 has a drive unit, the control portion 8 may also control the movement of the wheeled platform 40. These controls may be performed in response to an operation or an instruction accepted by the accepting portion 7, for example. The movement control of the wheeled platform 40 may be movement control concerning the movement direction and movement speed in response to an operation accepted by the accepting portion 7, or control of autonomous movement from a predetermined start point to a destination, for example. The specific control by the control portion 8 will be described later.

The first moving portion 10 supports the first and second hand portions 1 and 2 and moves each of the first and second hand portions 1 and 2 in the first direction. The first moving portion 10 can preferably move the first and second hand portions 1 and 2 independently of each other in the first direction, for example. The transport target object 5 can be held or released by the first and second hand portions 1 and 2 by causing the first moving portion 10 to move the first and second hand portions 1 and 2, for example. The transport target object 5 held by the first and second hand portions 1 and 2 can also be moved in the first direction by causing the first moving portion 10 to simultaneously move the first and second hand portions 1 and 2 in the same direction, for example.

The first moving portion 10 may include a first support portion 11 that supports the first and second hand portions 1 and 2, and linear actuators that move the first and second hand portions 1 and 2 in the first direction with respect to the first support portion 11, for example. More specifically, a guide along the first direction may be provided on the bottom face of the first support portion 11 extending in the first direction, and sliders may be assembled to the guide so as to be slidable in the first direction. The first and second base portions 1a and 2a of the first and second hand portions 1 and 2 may be respectively fixed to different sliders.

The second moving portion 20 supports the first moving portion 10 and moves the first moving portion 10 in the second direction. Thus, the second moving portion 20 moves the first and second hand portions 1 and 2 together in the second direction. The second moving portion 20 may include a second support portion 21 that supports the first support portion 11 of the first moving portion 10, and a linear actuator that moves the first support portion 11 in the second direction with respect to the second support portion 21, for example More specifically, a guide along the second direction may be provided on the bottom face of the second support portion 21 extending in the second direction, and a slider may be assembled to the guide so as to be slidable in the second direction. The upper face of the first support portion 11 may be fixed to the slider.

The third moving portion 30 supports the second moving portion 20 and moves the second moving portion 20 in the vertical direction. Thus, the third moving portion 30 moves the first and second hand portions 1 and 2 together in the vertical direction. The third moving portion 30 may include a pair of support posts 31 and 32 that are arranged at a distance from each other in the first direction, a top plate 33 that connects the upper ends of the support posts 31 and 32, a vertically moving portion 34 that is supported at its ends by the pair of support posts 31 and 32 and supports the second support portion 21 of the second moving portion 20, and a pair of linear actuators that synchronously move the vertically moving portion 34 in the vertical direction with respect to the pair of support posts 31 and 32, for example More specifically, guides along the vertical direction may be respectively provided on faces on the vertically moving portion 34 side of the support posts 31 and 32 extending in the vertical direction, and sliders may be assembled to the guides as to be slidable in the vertical direction. The two ends in the first direction of the vertically moving portion 34 may be respectively fixed to the sliders.

In the first to third moving portions 10, 20, and 30, for example, a slider may be assembled to two or more parallel guides. The linear actuators included in the first to third moving portions 10, 20, and 30 may independently have a rack and pinion mechanism and a drive unit for rotating the pinion, a ball screw mechanism and a drive unit for rotating the screw shaft of the ball screw mechanism, a pair of pulleys, an endless belt passed over the pair of pulleys, and a drive unit for rotating the pulleys, a mechanism using sprockets and an endless chain instead of the pulleys and belt, or other configurations, for example. The first moving portion 10 may include a linear actuator that moves the first hand portion 1 and a linear actuator that moves the second hand portion 2 in order to move the first and second hand portions 1 and 2 independently of each other in the first direction. The mechanisms for moving a supported object in a linear direction using a guide, a slider, a linear actuator, etc. are already well known, and thus its detailed description is omitted. In FIG. 1, guides, sliders, and linear actuators are not shown.

The third moving portion 30 is fixed to the wheeled platform 40. The base ends, that is, the lower ends of the third moving portion 30 may be fixed to the wheeled platform 40. The wheeled platform 40 may include a base 41 to which the base ends of the third moving portion 30 are fixed, and multiple traveling units 42 that are fixed to the base 41 and can travel on a traveling face such as a floor surface, for example. The base 41 may be a plate-like member, for example. The traveling units 42 are typically wheels, but may be those other than wheels, such as rollers, endless tracks, or ball casters with balls. The wheeled platform 40 may or may not have a drive unit for driving the traveling units 42. In the latter case, the wheeled platform 40 may be moved manually. The manually moved wheeled platform 40 may include a securing unit for securing the traveling units 42 in order to prevent the wheeled platform 40 from moving during the local transport of the transport target object 5 by the first to third moving portions 10, 20, and 30. The securing unit may be wheel stoppers, for example. In this embodiment, a case will be mainly described in which the wheeled platform 40 does not have a drive unit and is moved manually. The transport target object 5 is transported locally by the first to third moving portions 10, 20, and 30, whereas the transport target object 5 is transported in a larger area by the wheeled platform 40.

Hereinafter, the control of the first to third moving portions 10, 20, and 30 by the control portion 8 will be briefly described. If an operation to move at least one of the first and second hand portions 1 and 2 is accepted by the accepting portion 7, the control portion 8 may move at least one of the first and second hand portions 1 and 2 in the first direction by operating the drive units of the linear actuators included in the first moving portion 10, for example. If an operation to move the first moving portion 10 in the second direction is accepted by the accepting portion 7, the control portion 8 may move the first moving portion 10 in the second direction by operating the drive unit of the linear actuator included in the second moving portion 20, for example. If an operation to lift or lower the vertically moving portion 34 is accepted by the accepting portion 7, the control portion 8 may lift or lower the vertically moving portion 34 in the vertical direction by synchronously operating the drive units of the pair of linear actuators included in the third moving portion 30, for example. The control portion 8 may simultaneously operate at least two or more moving portions out of the first to third moving portions 10, 20, and 30, for example. More specifically, the control portion 8 may move the transport target object 5 simultaneously in the first and second directions by simultaneously operating the first and second moving portions 10 and 20. For example, if a predetermined operation program for the first to third moving portions 10, 20, and 30 has been set in advance, the control portion 8 may control the first to third moving portions 10, 20, and 30 such that an operation according to the set operation program is performed. Specifically, if the position at which the transport target object 5 is to be held when transport in a larger area using the wheeled platform 40 is performed is determined in advance, the control portion 8 may control the first to third moving portions 10, 20, and 30 to move the transport target object 5 to the predetermined position prior to its transport. In this embodiment, a case will be mainly described in which the control portion 8 controls the first to third moving portions 10, 20, and 30 in response to an operation accepted by the accepting portion 7, that is, the first to third moving portions 10, 20, and 30 are manually controlled.

Furthermore, when moving the second moving portion 20 upward according to an operation, an instruction, or the like accepted by the accepting portion 7 or an operation program or the like set in advance, for example, if the weights acquired by the first and second sensors 1c and 2c included in the first and second hand portions 1 and 2 match each other, the control portion 8 may control the third moving portion 30 to move the second moving portion 20 upward, or otherwise the control portion 8 may not control the third moving portion 30 to move the second moving portion 20 upward. Accordingly, for example, a situation can be avoided in which the second moving portion 20 is moved upward in a state in which the transport target object 5 is held by only one of the first and second hand portions 1 and 2. The state in which the weights acquired by the first and second sensors 1c and 2c match each other may be a state in which they exactly match each other or a state in which they match each other within the margin of error. The error may be a measurement error or an error according to the bias of the center of gravity of the transport target object 5, for example.

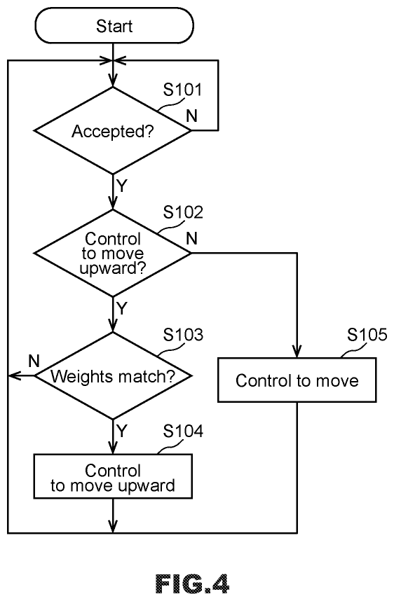

Next, an operation of the transport apparatus 100 will be described with reference to the flowchart in FIG. 4.

(Step S101) The accepting portion 7 determines whether or not an operation related to the first to third moving portions 10, 20, and 30 has been accepted. If such an operation has been accept, the procedure advances to step S102, or otherwise the processing in step S101 is repeated until the operation is accepted.

(Step S102) The control portion 8 determines whether or not an operation for performing control to move the first and second hand portions 1 and 2 upward has been accepted. If an operation for performing control to move the first and second hand portions 1 and 2 upward has been accepted, the procedure advances to step S103, or otherwise the procedure advances to step S105. The control portion 8 may determine that an operation for performing control to move the first and second hand portions 1 and 2 upward has been accepted, in the case in which an operation for lifting the vertically moving portion 34 of the third moving portion 30 has been accepted, for example.

(Step S103) The control portion 8 determines whether or not the weights acquired by the first and second sensors 1c and 2c match each other. If they match each other, the procedure advances to step S104, or otherwise the procedure returns to step S101. If the procedure returns to step S101, the user may be notified that the weights applied to the first and second hand portions 1 and 2 do not match each other, for example. This notification may be output by an output unit, for example. The output may be display, sound output, transmission, lighting of a warning light, or the like, for example.

(Step S104) The control portion 8 performs control to move the first and second hand portions 1 and 2 upward, that is, control to lift the vertically moving portion 34. Then, the procedure returns to step S101.

(Step S105) The control portion 8 performs control other than that for moving the first and second hand portions 1 and 2 upward, such as control to move the first and second hand portions 1 and 2 in the first direction or the second direction, control to lower the first and second hand portions 1 and 2, and the like, for example. Then, the procedure returns to step S101.

If control according to an operation program is to be performed, the control portion 8 may repeatedly determine whether or not the weights acquired by the first and second sensors 1c and 2c match each other, during the control to move the first and second hand portions 1 and 2 upward. If the weights match each other, the control portion 8 may continue to perform the control, or otherwise the control portion 8 may discontinue the control. If control using the weights acquired by the first and second sensors 1c and 2c is not performed, when an operation is accepted in the flowchart in FIG. 4, the first to third moving portions 10, 20, and 30 may be controlled according to the operation. In the flowchart in FIG. 4, the processing ends at power off or at an interruption of termination processing.

Next, an operation of the transport apparatus 100 according to this embodiment will be described by way of a specific example. In this specific example, a case will be described in which the transport target object 5 is transported from a first position to a second position.

First, the user manually moves the transport apparatus 100 to the vicinity of the transport target object 5 that is present at the first position. Then, after moving the transport apparatus 100 to the vicinity of the transport target object 5, the user secures the traveling units 42 of the wheeled platform 40 to prevent them from moving.

Subsequently, the user inputs an operation to the first to third moving portions 10, 20, and 30 to move the first and second holding portions 1b and 2b to a position at which the pair of holdable portions 5a of the transport target object 5 can be suspended (Steps S101, S102, and S105). Then, the user inputs an operation to the third moving portion 30 to cause the first and second holding portions 1b and 2b to suspend the pair of holdable portions 5a of the transport target object 5 (Steps S101 to S104). The user inputs an operation to the second moving portion 20 to move the transport target object 5 to a position near the center of the wheeled platform 40 in plan view (Steps S101, S102, and S105).

If only one of the first and second holding portions 1b and 2b has held the holdable portion 5a and the other has failed to hold the holdable portion 5a when the transport target object 5 is moved upward, the weights acquired by the first and second sensors 1c and 2c will be different and the upward movement of the transport target object 5 is canceled (Step S103). In this manner, a situation can be avoided in which the transport target object 5 is lifted while being held by only one of the first and second hand portions 1 and 2 and the transport target object 5 is damaged due to overturning or the like.

Next, the user cancels the securing of the traveling units 42 and manually moves the transport apparatus 100 to the vicinity of the second position. Subsequently, the user secures the traveling units 42 of the wheeled platform 40 to prevent them from moving. Then, the user inputs an operation to the second moving portion 20 to move the transport target object 5 in the positive direction of the x-axis and stops the movement when the transport target object 5 is above the second position (Steps S101, S102, and S105). The user inputs an operation to the third moving portion 30 to move the transport target object 5 downward and stops the movement when the transport target object 5 is placed on the floor surface at the second position and the first and second holding portions 1b and 2b can be removed from the pair of holdable portions 5a through horizontal movement (Steps S101, S102, and S105). Then, the user inputs an operation to the first moving portion 10 to move the first hand portion 1 in the negative direction of the y-axis and the second hand portion 2 in the positive direction of the y-axis, and thus the first and second hand portions 1 and 2 release the transport target object 5 (Steps S101, S102, and S105). In this manner, the transport target object 5 can be moved to the desired position.

The transport apparatus 100 may pick up the transport target object 5 that is placed on a shelf, a stand, or the like instead of on the floor surface, or may transport the transport target object 5 to a shelf, a stand, or the like, for example. The transport apparatus 100 may also transport the transport target object 5 such that it is positioned against a member for positioning disposed at the destination. Specifically, the transport target object 5 may be positioned along a guide member or the like for positioning at the destination.

As described above, with the transport apparatus 100 according to this embodiment, the first and second hand portions 1 and 2 are moved together in the second direction and the vertical direction, thereby reducing the number of axes and simplifying the configuration for moving the first and second hand portions 1 and 2 compared with that of dual-arm robots. As a result, the weight of the first and second hand portions 1 and 2 side can be prevented from increasing, and the weight capacity can be correspondingly increased. In addition, since the number of parts is reduced compared with that of dual-arm robots, the weight of the transport apparatus 100 can be reduced, and the overall size of the apparatus can also be reduced. The first to third moving portions 10, 20, and 30 can move the first and second hand portions 1 and 2 in the three axial directions, and can position the transport target object 5 held by the first and second hand portions 1 and 2, for example. The wheeled platform 40 can realize large-area transportation of the transport target object 5 held by the first and second hand portions 1 and 2. Accordingly, for example, the transport apparatus 100 can be used to change the layout of heavy objects at a manufacturing site, for example. When the first and second hand portions 1 and 2 hold the transport target object 5 in a suspending manner, the transport target object 5 can be prevented from being displaced when the holding is canceled, enabling precise positioning.

Furthermore, as described above, the first and second holding portions 1b and 2b that hold the transport target object 5 in a suspending manner may have cross-sections in the shape other than the letter “J”. The first and second hand portions 1 and 2 may hold the transport target object 5 in a suspending manner, using the first and second holding portions 1b and 2b each having a cross-section in the shape of the letter “L” as shown in FIG. 2B, for example.

Furthermore, the first and second hand portions 1 and 2 may hold the transport target object 5 by means of electromagnets. In this case, for example, as shown in FIG. 2C, the upper face of the transport target object 5 may be held by the first and second holding portions 1b and 2b constituted by electromagnets. It is preferable that the transport target object 5 held by the first and second holding portions 1b and 2b constituted by electromagnets is typically made of a ferromagnetic material such as iron. If the transport target object 5 is made of a material other than a ferromagnetic material, a holdable portion made of a ferromagnetic material may be provided on the transport target object 5, for example. The face of the transport target object 5 that comes into contact with the first and second holding portions 1b and 2b constituted by electromagnets is preferably flat. If the first and second holding portions 1b and 2b are constituted by electromagnets, the electromagnets may be energized when holding the transport target object 5 and de-energized when canceling the holding. If the first and second hand portions 1 and 2 hold the transport target object 5 by means of electromagnets, the transport target object 5 can be prevented from being displaced when the holding is canceled, enabling precise positioning. If the transport target object 5 is made of a ferromagnetic material, a holdable portion does not have to be provided on the transport target object 5.

Furthermore, the first and second hand portions 1 and 2 may hold the transport target object 5 in a sandwiching manner from both sides in the first direction. In this case, for example, the first and second holding portions 1b and 2b each having a cross-section in the shape of the letter “U” as shown in FIG. 2D may be used to hold the transport target object 5 in a sandwiching manner. The first and second holding portions 1b and 2b may be arranged such that openings of the U-shaped areas face each other as shown in FIG. 2D. In the case of holding the transport target object 5 in a sandwiching manner, in order to enable the first and second holding portions 1b and 2b to hold the transport target object 5 placed on a placement face such as the floor surface, end edges that come into contact with the placement face, out of the end edges on the opening sides of the U-shaped first and second holding portions 1b and 2b, may each have a wedge shape. The wedge shape may be inclined such that the height of the upper face increases from the opening side toward the bottom side of the U-shaped area, as shown in FIG. 2D. If there is a gap between the peripheral edge of the transport target object 5 and the placement face in a state in which the transport target object 5 is placed on the placement face such as the case in which the position of the peripheral edge of the transport target object 5 is higher than that of its center, for example, the opening sides of the first and second holding portions 1b and 2b do not have to have a wedge shape. The first and second holding portions 1b and 2b each having a cross-section in the shape other than the letter “U” such as the first and second holding portions 1b and 2b each having a cross-section in the shape of the letter “L” may be used to hold the transport target object 5 in a sandwiching manner. If the first and second hand portions 1 and 2 hold the transport target object 5 in a sandwiching manner in this manner, a holdable portion does not have to be provided on the transport target object 5.

FIG. 2D shows a state in which both ends in the first direction (i.e., the left-right direction of the drawing) of the transport target object 5 are in contact with the bottoms of the U-shaped areas of the first and second holding portions 1b and 2b, but there is no limitation to this. The first and second holding portions 1b and 2b may hold the transport target object 5 in a sandwiching manner from both sides within the range where both ends in the first direction of the transport target object 5 are not in contact with the bottoms of the U-shaped areas of the first and second holding portions 1b and 2b.

Furthermore, in the case of positioning the transport target object 5 using a member for positioning disposed at the destination of the transport target object 5, there may be play between the first and second hand portions 1 and 2 and the transport target object 5 in a state in which the first and second hand portions 1 and 2 hold the transport target object 5. That is to say, the relative positional relationship between the first and second hand portions 1 and 2 and the transport target object 5 may not be fixed and may be changeable in a state in which the first and second hand portions 1 and 2 hold the transport target object 5. Furthermore, faces of the first and second hand portions 1 and 2 that come into contact with the transport target object 5 when the first and second hand portions 1 and 2 hold the transport target object 5 may be faces with a low coefficient of friction. The faces with a low coefficient of friction may be faces constituted by or coated with a material with a low coefficient of friction such as fluororesin or monomer-cast nylon. The fluororesin is not particularly limited, but may be polytetrafluoroethylene, FEP (perfluoroethylene-propene copolymer), PFA (perfluoroalkoxyalkane), or the like, for example. The monomer-cast nylon is particularly preferably of sliding grade, and may be sliding grade MC nylon (registered trademark), for example Since there is play between the first and second hand portions 1 and 2 and the transport target object 5 in a state in which the first and second hand portions 1 and 2 hold the transport target object 5, or since faces of the first and second hand portions 1 and 2 that come into contact with the transport target object 5 at that time are faces with a low coefficient of friction in this manner, the transport target object 5 can move more easily over the first and second hand portions 1 and 2 during positioning of the transport target object 5, resulting in more appropriate positioning.

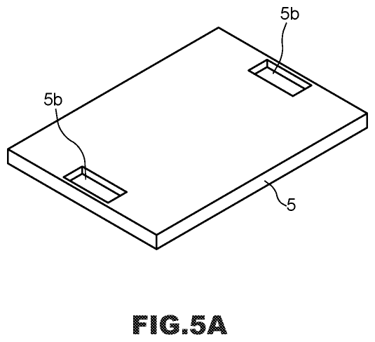

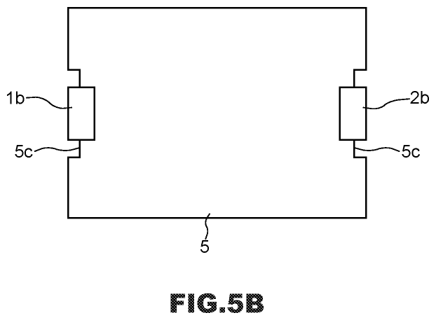

Even in the case in which there is play between the first and second hand portions 1 and 2 and the transport target object 5 in a state in which the first and second hand portions 1 and 2 hold the transport target object 5, the transport target object 5 is preferably prevented from falling from the first and second hand portions 1 and 2. Accordingly, for example, if the first and second holding portions 1b and 2b constituted by electromagnets hold the transport target object 5 as shown in FIG. 2C, the first and second holding portions 1b and 2b constituted by electromagnets may hold the transport target object 5, at the positions of recesses 5b in the upper face of the transport target object 5 as shown in FIG. 5A. The recesses 5b are regions recessed downward from the upper face of the transport target object 5. The bottom faces of the recesses 5b are preferably flat. The regions of the recesses 5b in plan view are set to be larger than the faces of the first and second holding portions 1b and 2b that come into contact with the transport target object 5. Accordingly, even when the positions at which the transport target object 5 is held by the first and second holding portions 1b and 2b constituted by electromagnets change, the contact faces of the first and second holding portions 1b and 2b will be within the regions of the recesses 5b, and the first and second holding portions 1b and 2b can be prevented from being detached from the transport target object 5. For example, if the first and second holding portions 1b and 2b each having a cross-section in the shape of the letter “U” as shown in FIG. 2D hold the transport target object 5 in a sandwiching manner, the first and second holding portions 1b and 2b may hold the transport target object 5, at the positions of recesses 5c in both sides in the first direction of the transport target object 5 as shown in FIG. 5B. FIG. 5B is a plan view showing the transport target object 5 and the first and second holding portions 1b and 2b. It is assumed that the recesses 5c are recessed toward the center of the transport target object 5, and the length of the recesses 5c is longer than that of the first and second holding portions 1b and 2b in the second direction. Accordingly, even when the relative positional relationship between the first and second holding portions 1b and 2b each having a cross-section in the shape of the letter “U” and the transport target object 5 changes, the first and second holding portions 1b and 2b can be prevented from being detached from the transport target object 5.

Furthermore, in this embodiment, a case was mainly described in which the first and second hand portions 1 and 2 respectively include the first and second sensors 1c and 2c for acquiring the weights of the transport target object 5 held by the first and second holding portions 1b and 2b, but there is no limitation to this. The first and second hand portions 1 and 2 do not have to include the first and second sensors 1c and 2c. In this case, the control portion 8 does not have to perform control using the weights acquired by the first and second sensors 1c and 2c.

Furthermore, in the transport apparatus 100 according to this embodiment, the vertically moving portion 34 may be connected to an end of a linear member such as a rope, a wire, or a chain passed over a pulley, and a counterweight may be connected to the other end of that linear member. Accordingly, a heavier transport target object 5 can be moved in the vertical direction with less force.

In the foregoing embodiment, each process or each function may be realized as centralized processing using a single apparatus or a single system, or may be realized as distributed processing using multiple apparatuses or multiple systems.

In the foregoing embodiment, each constituent element may be configured by dedicated hardware, or alternatively, constituent elements that can be realized by software may be realized by executing a program. For example, each constituent element may be realized by a program execution unit such as a CPU reading and executing a software program stored in a recording medium such as a hard disk or a semiconductor memory. At the time of executing the program, the program execution unit may execute the program while accessing the storage unit or the recording medium. Furthermore, this program may be executed by downloading from a server or the like, or may be executed by reading a program stored in a predetermined recording medium (e.g., an optical disk, a magnetic disk, a semiconductor memory, etc.). Furthermore, the program may be used as a program for constituting a program product. Furthermore, a computer that executes the program may be a single computer or may be multiple computers. That is to say, centralized processing may be performed, or distributed processing may be performed.

Furthermore, the foregoing embodiment is an example for specific implementation of the present invention and is not intended to limit the technical scope of the invention. The technical scope of the invention is indicated by the claims rather than by the foregoing description, and changes which come within the wording and equivalent meanings of the scope of the claims are intended to be encompassed therein.

What is claimed is:

1. A transport apparatus comprising:
first and second hand portions that are arranged at a distance from each other in a first direction in a horizontal plane and configured to simultaneously hold a transport target object;
a first moving portion that moves each of the first and second hand portions in the first direction;
a second moving portion that moves the first moving portion in a second direction that is perpendicular to the first direction in the horizontal plane;
a third moving portion that moves the second moving portion in a vertical direction; and
a wheeled platform to which the third moving portion is fixed.

2. The transport apparatus according to claim 1, wherein the first and second hand portions hold the transport target object in a suspending manner.

3. The transport apparatus according to claim 1, wherein the first and second hand portions hold the transport target object in a sandwiching manner from both sides in the first direction.

4. The transport apparatus according to claim 1, wherein the first and second hand portions hold the transport target object by means of electromagnets.

5. The transport apparatus according to claim 1, further comprising a control portion that controls each of the first to third moving portions,
wherein the first and second hand portions respectively have sensors for acquiring weights of the transport target object, and
in a case in which the weights acquired by the sensors respectively included in the first and second hand portions match each other, the control portion controls the third moving portion to move the second moving portion upward.
